(19) United States
(12) Patent Application Publication
(10) Pub. No.: US 2026/0105249 A1
(43) Pub. Date: Apr. 16, 2026

(54) SYSTEMS AND METHODS FOR DOCUMENT GENERATION USING LINKED MEDIA ASSETS

(71) Applicant: ADOBE INC., SAN JOSE, CA (US)

(72) Inventors: Justin Aaron Reimer, Seattle, WA (US); Vadim Furman, Kirkland, WA (US); Moira Dewey, Seattle, WA (US); Joseph Jazdzewski, Brier, WA (US); Chidrup Mahakali, Redwood City, CA (US); Shallin Partap Singh, Dublin, CA (US); Namita Bansal, Fremont, CA (US); Mila Levkovsky, Los Angeles, CA (US); Margaret Trinh, Seattle, WA (US)

(21) Appl. No.: 19/273,443

(22) Filed: Jul. 18, 2025

Related U.S. Application Data
(60) Provisional application No. 63/706,127, filed on Oct. 11, 2024.

(51) Int. Cl. G06F 40/186; G06F 3/0486; G06F 40/106; G06F 40/134; G06F 40/177

(52) U.S. Cl. CPC G06F 40/186; G06F 3/0486; G06F 40/106; G06F 40/134; G06F 40/177

(57) ABSTRACT

A method, apparatus, non-transitory computer readable medium, and system for media generation include displaying a data structure and a plurality of media assets, where each element of the data structure includes a plurality of document attributes, receiving a user input linking a media asset of the plurality of media assets to a corresponding element of the data structure, and generating a document based on the user input, where the document includes the media asset and plurality of document attributes from the corresponding element of the data structure.

### CROSS-REFERENCE TO RELATED APPLICATION

This application claims priority under 35 U.S.C. § 119 to U.S. Provisional Application No. 63/706,127, filed on Oct. 11, 2024, in the United States Patent and Trademark Office, the disclosure of which is incorporated by reference herein in its entirety.

### BACKGROUND

The following relates to document generation. Document generation refers to a process of creating documents using pre-defined templates and/or data inputs, allowing manual input and repetitive tasks to be minimized and helping to provide a consistency in style, format, and content structure. Additionally, document generation allows for customization based on specific data inputs and can be integrated with databases and software applications to incorporate current information.

### SUMMARY

Systems and methods are described for document generation using linked media assets. In some embodiments, a media generation system generates a document based on a user inputs that links an element of a data structure (e.g., a row of a table) to a media asset, such as an image or a video. The document generation component can generate one document for each element of the data structure, where each document respectively includes a linked media asset. By displaying the data structure alongside the set of media assets and linking the media assets to elements of the data structure, the media generation system provides a more efficient document generation process than conventional media generation systems.

This Summary introduces a selection of concepts in a simplified form that are further described below in the Detailed Description. As such, this Summary is not intended to identify essential features of the subject matter, nor is it intended to be used as an aid in determining the scope of the subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of a media generation system according to aspects of the present disclosure.

FIG. 2 shows an example of a method for generating a document according to aspects of the present disclosure.

FIG. 3 shows an example of a user interface for linking media assets according to aspects of the present disclosure.

FIG. 4 shows an example of a user interface for displaying linked media assets according to aspects of the present disclosure.

FIG. 5 shows an example of a user interface for displaying document previews according to aspects of the present disclosure.

FIG. 6 shows an example of a user interface for displaying representations of documents according to aspects of the present disclosure.

FIG. 7 shows an example of a user interface for obtaining local media assets according to aspects of the present disclosure.

FIG. 8 shows an example of a user interface for obtaining nonlocal media assets according to aspects of the present disclosure.

FIG. 9 shows an example of a user interface for previewing nonlocal media assets according to aspects of the present disclosure.

FIG. 10 shows an example of a user interface for displaying a document template according to aspects of the present disclosure.

FIG. 11 shows an example of a user interface for selecting a text element according to aspects of the present disclosure.

FIG. 12 shows an example of a user interface for connecting a text element to a document attribute category according to aspects of the present disclosure.

FIG. 13 shows an example of a user interface for displaying connected text elements according to aspects of the present disclosure.

FIG. 14 shows an example of generated documents according to aspects of the present disclosure.

FIG. 15 shows an example of a method for generating a document including a media asset according to aspects of the present disclosure.

FIG. 16 shows an example of a method for generating a document based on a document template according to aspects of the present disclosure.

FIG. 17 shows an example of a computing device according to aspects of the present disclosure.

FIG. 18 shows an example of a media generation apparatus according to aspects of the present disclosure.

### DETAILED DESCRIPTION

### Overview

The following relates to document generation. Document generation refers to a process of creating documents using pre-defined templates and/or data inputs, allowing manual input and repetitive tasks to be minimized and helping to provide a consistency in style, format, and content structure. Additionally, document generation allows for customization based on specific data inputs and can be integrated with databases and software applications to incorporate current information.

However, conventional document generation processes are inefficient because they rely upon a user navigation of multiple user interface windows to select media assets for inclusion in documents and provide cumbersome mechanisms for adding the selected media assets to the documents.

Accordingly, systems and methods are described for document generation using linked media assets. In some embodiments, a media generation system generates a document based on a user inputs that links an element of a data structure such as a document table to a media asset, such as an image or a video. The document generation component may generate one document for each element of the document table, where each document respectively includes a linked media asset. By displaying the document table alongside a set of media assets and linking the media assets to rows of the document table, the media generation system provides a more efficient document generation process than conventional media generation systems.

At least one aspect of the present disclosure enables users to create a new set of documents from an original design template, where the text and assets vary across pages, producing new content that is mapped from a source spreadsheet. Users can create a set of documents including different headlines, imagery, messaging, etc. with just a few clicks. Embodiments of the present disclosure help users to quickly upload a set of media assets so that the users can map the set of media asserts to each document for efficient document generation.

### Terminology Examples

A “document” includes any media item that can include a media asset. A document may also include one or more text elements. Examples of a document include a word processing file, a text file, a spreadsheet file, a presentation slide file, a Portable Document Format (PDF) file, a website, a smartphone or tablet app, an image file, and the like. A “media asset” refers to an image or a video.

A “document template” refers to a representation of a document having one or more selectable elements. A “data structure” refers to a structured representation of data attributes such as a table, an ordered list, a hierarchical data structure, etc. A “document table” is a data structure including rows and columns, where each column corresponds to an attribute category and each row corresponds to one document. A “document attribute” refers to a value (e.g., content, such as text or a media asset) for populating a corresponding element of a corresponding document.

A “media asset element” refers to a field of a document template that may be populated with a media asset. A media asset element may be associated with a perimeter or boundary size for displaying the media asset within the media asset element. A media asset element may be pre-populated with a dummy media asset. A “text element” refers to a field of a document template that may be populated with text. A text element may be associated with a style (e.g., size, color, font, spacing) for displaying the text within the text element. A text element may be pre-populated with dummy text. A “template element” refers to a field of a document template that may be populated with content, such as a media asset or text.

An example of the media generation system is used in a batch document generation context. In the example, a user selects a document template including an image element (media asset element) and various text elements. A user interface of the media generation system displays a document table, where each element of the table includes a value for the image element and different values for the text elements of the document template, such that each element corresponds to a different document to be generated based on the document template and the values of the document table.

The user selects a set of images from local storage or a cloud storage location. The user interface displays the set of images alongside the document table. The user associates each row of the table with an image by dragging the image onto the row of the table. The media processing system then generates a set of documents by populating the document with values from the document table, where each generated document includes an image respectively associated with the document via the document table. Accordingly, the media processing system allows the user to easily and efficiently perform batch document generation.

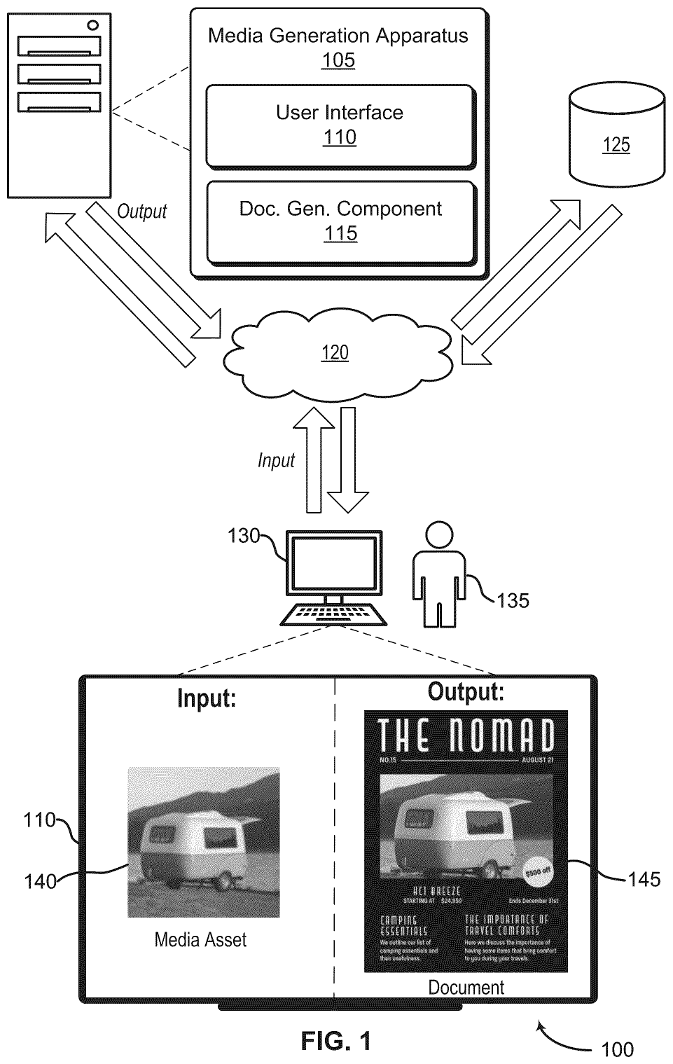

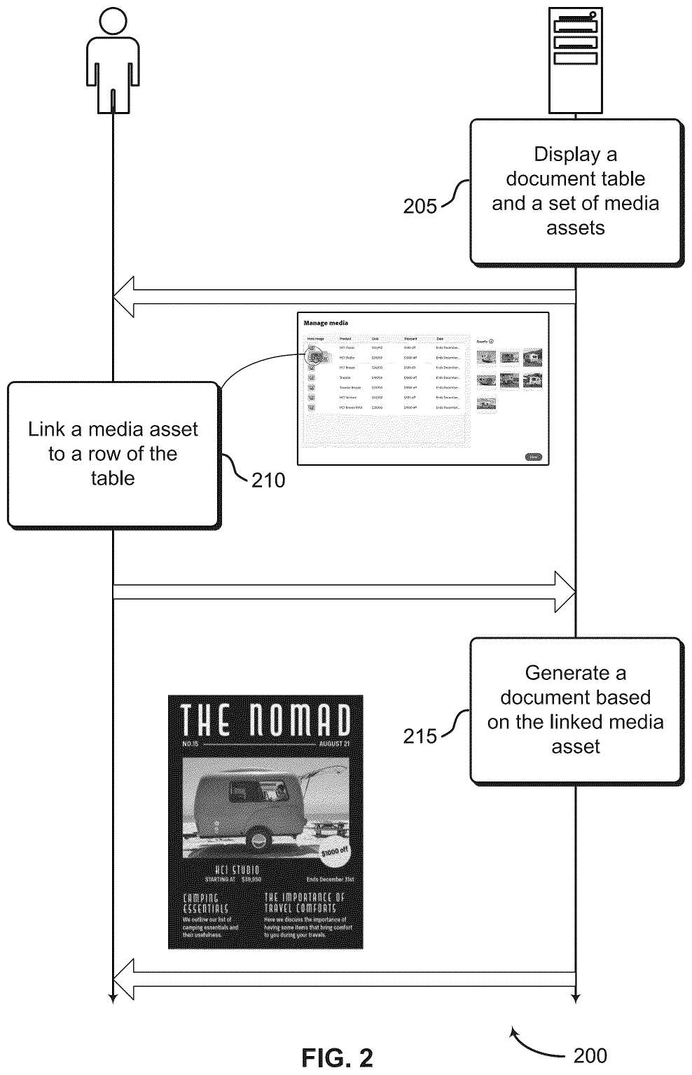

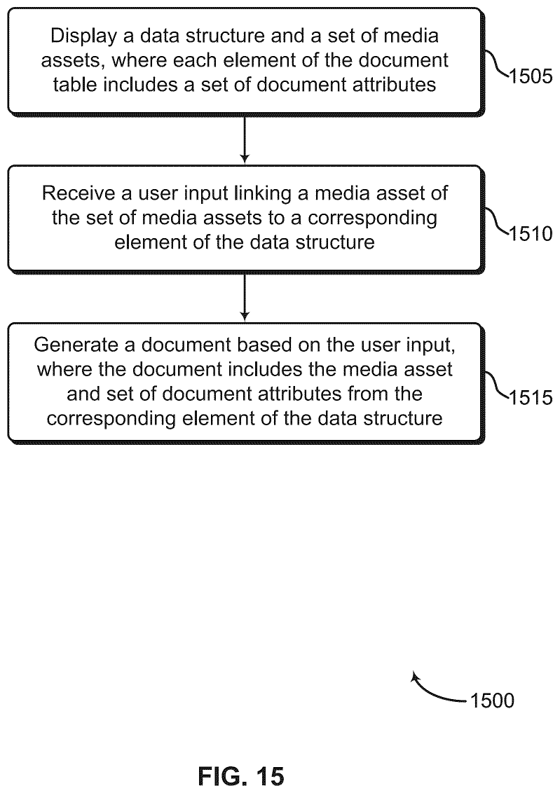

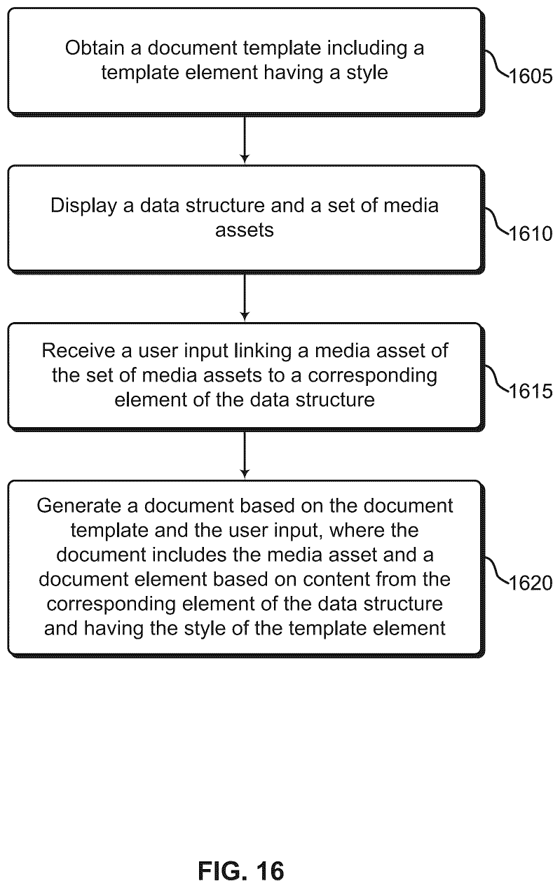

Further example applications of the present disclosure in a document generation context are provided with reference to FIGS. 1-2. Details regarding the architecture of a media generation system are provided with reference to FIGS. 1-14 and 17-18. Details regarding a process for document generation are provided with reference to FIGS. 15-16.

Examples of the present disclosure improve upon conventional media generation systems by making a document generation process more efficient. For example, some embodiments achieve this efficiency by displaying a set of media assets next to a data structure, where each row of the data structure includes attributes for a document, receiving a user input linking a media asset of the set of media assets to an element of the data structure, and generating a document based on the attributes of the element of the data structure and the linked media asset.

Because the data structure and the media asset are displayed next to each other, the user input linking the media asset and the data structure is easily and efficiently provided, thereby increasing an efficiency of a document generation process. By contrast, conventional media generation systems use multiple different user interface windows to identify and associate media assets with document templates.

### Media Generation System

FIG. 1 shows an example of a media generation system 100 according to aspects of the present disclosure. The example shown includes media generation system 100, user device 130, user 135, media asset 140, and document 145. In one aspect, media generation system 100 includes media generation apparatus 105, cloud 115, and database 125. In one aspect, media generation apparatus 105 includes user interface 110 and document generation component 115.

Referring to FIG. 1, a user (e.g., user 135) provides a media asset (e.g., media asset 140) to media generation apparatus 105 via user interface 110 displayed on a user device (e.g., user device 130) by media generation apparatus 105. The user provides an input to user interface 110 to link the media asset to an element of a data structure including document attributes s for a document. Media generation apparatus 105 generates the document (e.g., document 145) using document generation component 115 by applying the linked media asset and the document attributes to a document template. User interface 110 displays the generated document to the user.

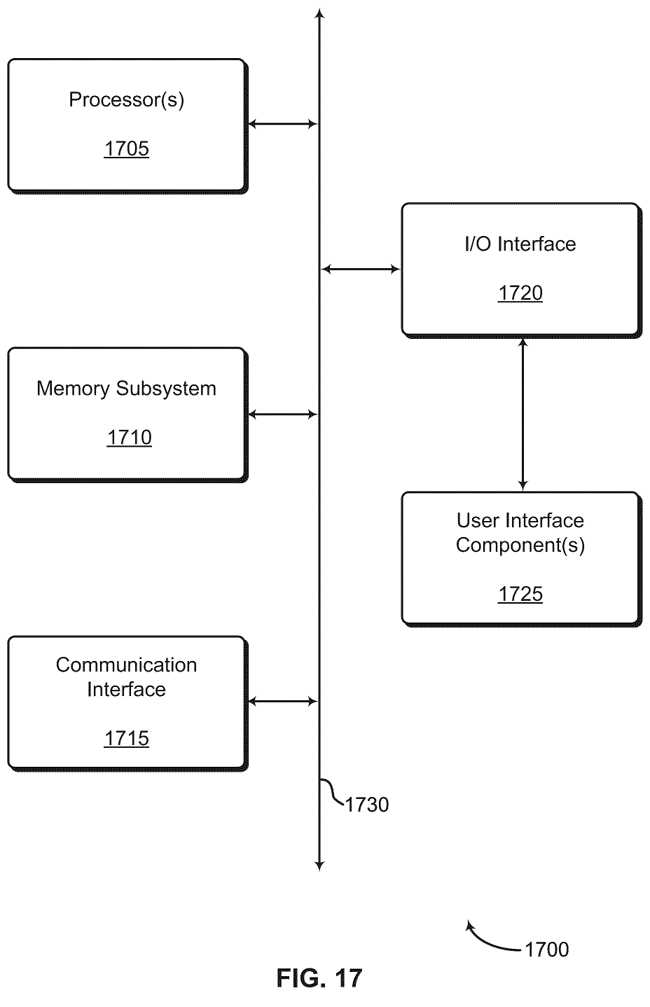

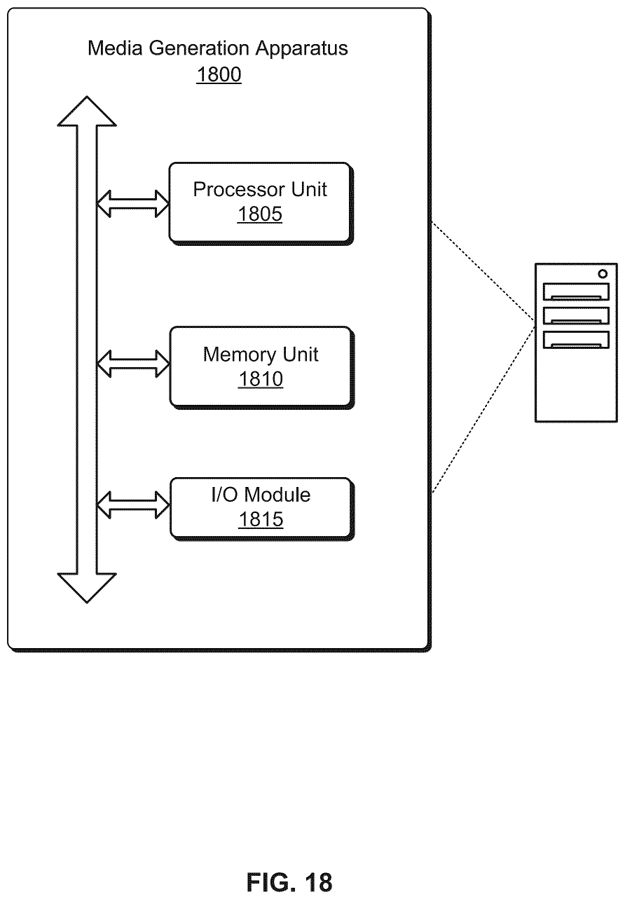

Media generation apparatus 105 is an example of, or includes aspects of, the corresponding element described with reference to FIGS. 17 and 18. According to some aspects, media generation apparatus 105 includes a computer-implemented network. Media generation apparatus 105 may also include one or more processors, a memory subsystem, a communication interface, an I/O interface, one or more user interface components, and a bus as described with reference to FIG. 17. Additionally, media generation apparatus 105 may communicate with user device 130 and database 125 via cloud 115.

According to some aspects, media generation apparatus 105 is implemented on a server. A server provides one or more functions to users linked by way of one or more of various networks, such as cloud 115. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

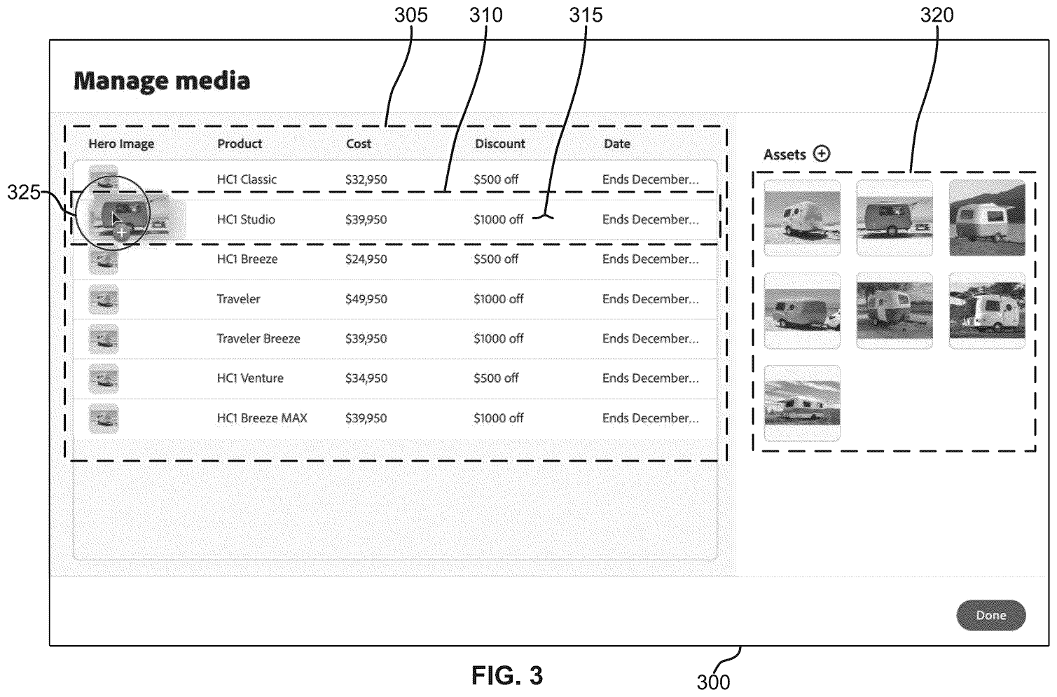

User interface 110 is an example of, or includes aspects of, the corresponding element described with reference to FIGS. 3-13. According to some aspects, user interface 110 comprises a text interface, a graphical user interface, or a combination thereof.

According to some aspects, user interface 110 displays a data structure and a set of media assets, where each element of the data structure includes a set of document attributes. In some examples, user interface 110 receives a user input linking a media asset of the set of media assets to a corresponding element of the data structure. In some examples, user interface 110 receives at least one additional user input linking each of the remaining media assets of the set of media assets to an element of the data structure. In some aspects, the data structure is displayed in a first window and the set of media assets are displayed in a second window adjacent to the first window. In some examples, user interface 110 obtains a document template, where the document is generated based on the document template. In some aspects, a set of columns of the data structure correspond to the set of document attributes. In some examples, user interface 110 displays the preview adjacent to the data structure.

According to some aspects, user interface 110 obtains a document template including a template element having a style. In some examples, user interface 110 displays a data structure and a set of media assets. In some examples, user interface 110 receives a user input linking a media asset of the set of media assets to a corresponding element of the data structure. In some aspects, the style includes one or more of a font, a font size, and spacing. In some examples, user interface 110 receives at least one additional user input linking each of the remaining media assets of the set of media assets to an element of the data structure. In some aspects, the data structure is displayed in a first window and the set of media assets are displayed in a second window adjacent to the first window. In some aspects, the user input includes a drag-and-drop operation from the set of media assets to the data structure.

According to some aspects, document generation component 115 generates a document based on the user input, where the document includes the media asset and set of document attributes from the corresponding element of the data structure. In some examples, document generation component 115 generates a set of documents corresponding to each of the remaining media assets based on the at least one additional user input. In some aspects, the set of document attributes correspond to fields of the document template. In some examples, document generation component 115 generates a preview corresponding to the document, where the preview includes the media asset and the set of document attributes from the corresponding element of the data structure.

According to some aspects, document generation component 115 generates a document based on the document template and the user input, where the document includes the media asset and content from the corresponding element of the data structure and having the style of the template element. In some examples, document generation component 115 generates a set of documents corresponding to each of the remaining media assets based on the at least one additional user input. In some examples, document generation component 115 obtains the content from a data source. In some examples, document generation component 115 maps the content to the data structure. In some examples, document generation component 115 resizes the content based on a boundary of the template element. According to some aspects, document generation component 1820 comprises executable instructions stored in memory unit 1810, one or more hardware circuits, or firmware.

Further detail regarding the architecture of a media generation system is provided with reference to FIGS. 2-14 and 17-18. Further detail regarding processes for generating a document is provided with reference to FIGS. 15-16.

Cloud 115 is a computer network configured to provide on-demand availability of computer system resources, such as data storage and computing power. Cloud 115 may provide resources without active management by a user. The term “cloud” is sometimes used to describe data centers available to many users over the Internet. Some large cloud networks have functions distributed over multiple locations from central servers. A server is designated an edge server if the server has a direct or close connection to a user. Cloud 115 may be limited to a single organization or be available to many organizations. In one example, cloud 115 includes a multi-layer communications network comprising multiple edge routers and core routers. In another example, cloud 115 is based on a local collection of switches in a single physical location. According to some aspects, cloud 115 provides communications between media generation apparatus 105, database 125, and user device 130.

Database 125 is an organized collection of data. In an example, database 125 stores data in a specified format known as a schema. According to some aspects, database 125 is structured as a single database, a distributed database, multiple distributed databases, or an emergency backup database. A database controller may manage data storage and processing in database 125. A user may interact with the database controller, or the database controller may operate automatically without interaction from the user. According to some aspects, database 125 is included in media generation apparatus 105. According to some aspects, database 125 is external to media generation apparatus 105 and communicates with media generation apparatus 105 via cloud 115.

According to some aspects, user device 130 is a personal computer, laptop computer, mainframe computer, palmtop computer, personal assistant, mobile device, or any other suitable processing apparatus. User device 130 may include software that displays user interface 110 provided by media generation apparatus 105. The user interface 110 allows information to be communicated between the user and media generation apparatus 105.

According to some aspects, a user device user interface enables a user to interact with user device 130. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

FIG. 2 shows an example of a method 200 for generating a document according to aspects of the present disclosure. Referring to FIG. 2, a media generation system (such as the media generation system 100 described with reference to FIG. 1) generates a set of documents based on user inputs that respectively link elements of a data structure to media assets such as images or video. The document generation component generates one document for each element of the data structure, where each document includes the linked media asset.

At operation 205, the system displays a data structure and a set of media assets. In some cases, the operations of this step refer to, or may be performed by, a media generation system as described with reference to FIG. 1. In an example, a user interface of the media generation system (such as the user interface 110 described with reference to FIG. 1) displays the data structure and the set of media assets as described with reference to FIG. 3.

At operation 210, a user links a media asset of the set of media assets to an element of the data structure (e.g., a row of a table). In some cases, the operations of this step refer to, or may be performed by, a user as described with reference to FIG. 1. In an example, the user provides a drag-and-drop user input to drag the media asset onto the row of the table as described with reference to FIG. 3.

At operation 215, the system generates a document based on the linked media asset. In some cases, the operations of this step refer to, or may be performed by, a media generation system as described with reference to FIG. 1. In an example, the media generation system generates the document based on the linked media asset as described with reference to FIGS. 3-6.

FIG. 3 shows an example of a user interface 300 for linking media assets according to aspects of the present disclosure. The example shown includes user interface 300, media assets 320, and user input 325. In one aspect, user interface 300 includes data structure 305. In one aspect, data structure 305 includes element 310. In one aspect, element 310 includes document attributes 315.

Referring to FIG. 3, user interface 300 displays a data structure (e.g., data structure 305) adjacent to media assets (e.g., media assets 320). The data structure includes one or more elements (e.g., element 310). Each of the elements includes document attributes for a document (e.g., document attributes 315). Each column of the data structure corresponds to a category for the document attributes. The document attributes include text, a media asset representation, or a combination thereof. In the example of FIG. 3, document attributes 315 in element 310 include a media asset representation in a “Hero Image” category, text “HC1 Studio” in a “Product” category, text “$39,950” in a “Cost” category, and text “$1000 off” in a “Discount” category. In some embodiments, the data structure shown by user interface 300 does not show each document attribute for a document.

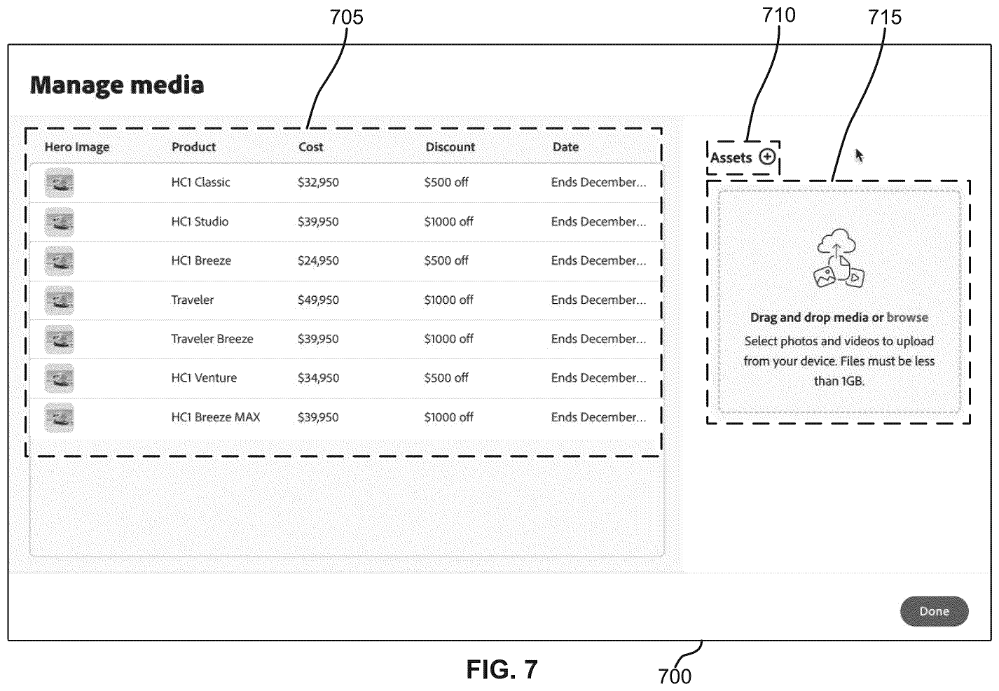

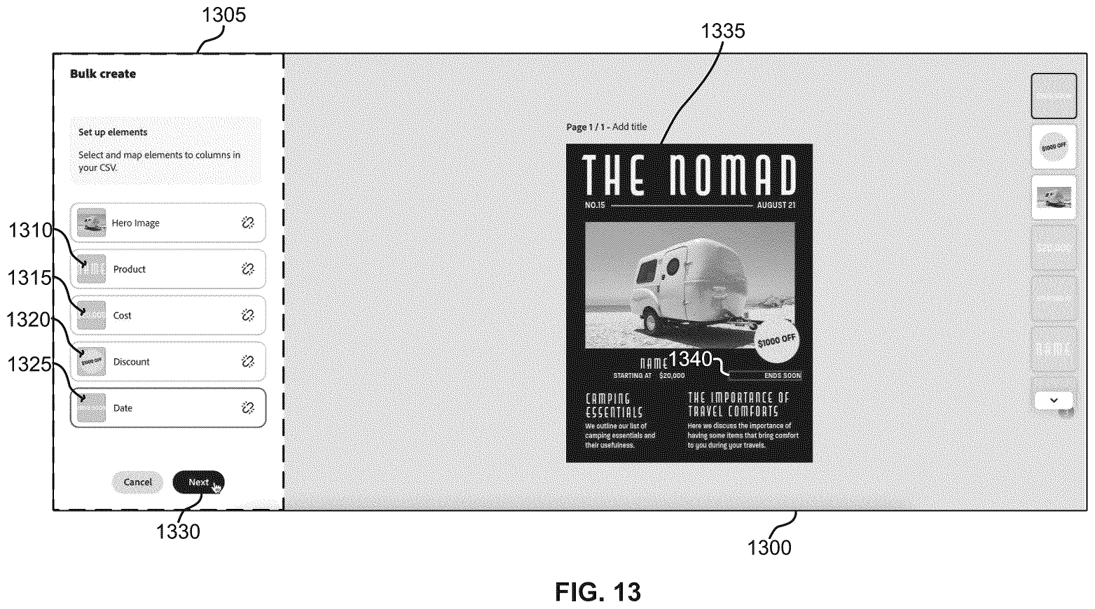

In the example of FIG. 3, media assets 320 are images. The media assets may be obtained by user interface 300 as described with reference to FIGS. 7-9. A user may link one of the media assets by a user input. FIG. 3 shows a click-and-drag user input 325 in which a media asset is linked to the document associated with element 310 by dragging the media asset onto the media asset representation document attribute of element 310. In some embodiments, data structure 305 is generated as described with reference to FIG. 13.

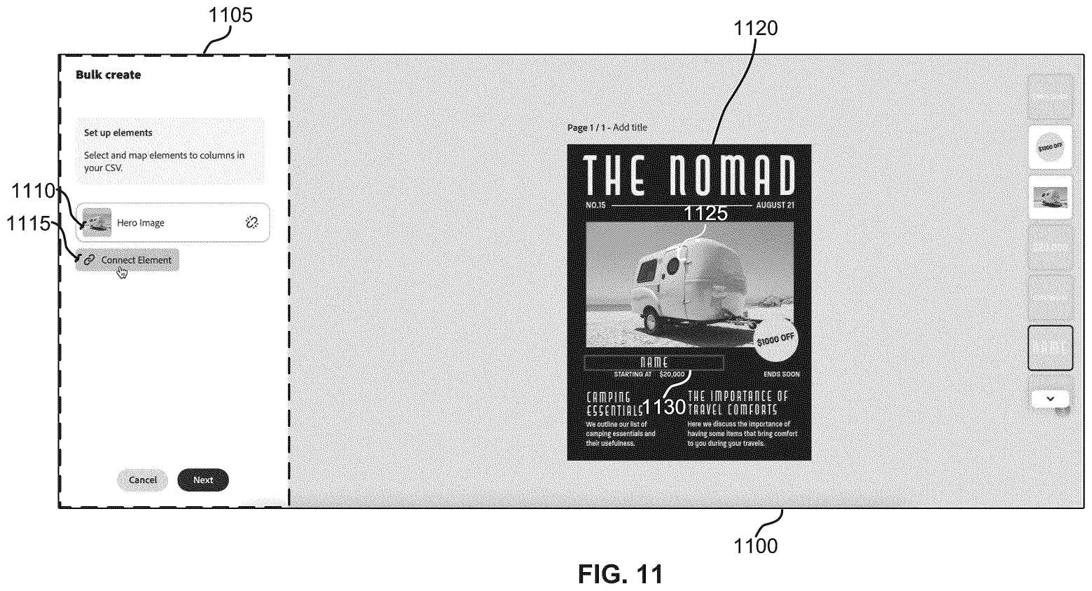

A document generation component may generate a document preview in response to the user input. In an example, the document generation component generates the document preview by populating a media asset element of a document template that has been linked to the media asset representation document attribute category as described with reference to FIG. 11 with the media asset.

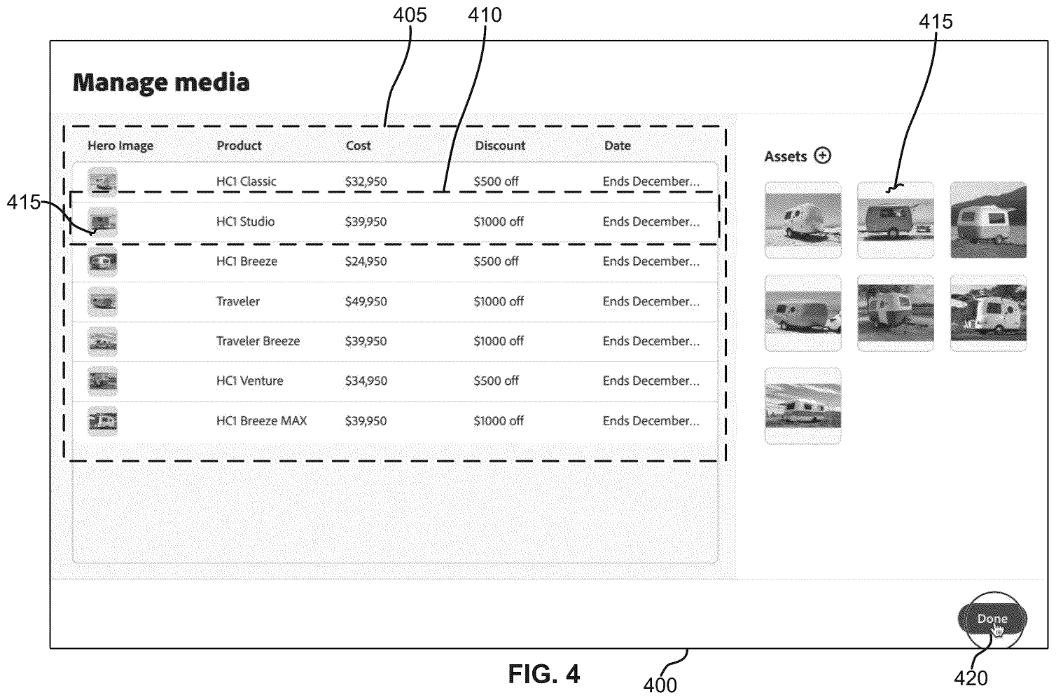

User interface 300 is an example of, or includes aspects of, the corresponding element described with reference to FIGS. 1, and 4-13. Data structure 305 is an example of, or includes aspects of, the corresponding element described with reference to FIGS. 4, 5, and 7-9. Element 310 is an example of, or includes aspects of, the corresponding element described with reference to FIG. 4.

FIG. 4 shows an example of a user interface 400 for displaying linked media assets according to aspects of the present disclosure. In one aspect, user interface 400 includes data structure 405 and “Done” button 420. In one aspect, data structure 405 includes element 410. In one aspect, element 410 includes linked media asset 415.

Referring to FIG. 4, user interface 400 may display a data structure (e.g., data structure 405) including elements (including, e.g., element 410) that include representations of media assets (including, e.g., media asset 415) that have been linked with the elements as described with reference to FIG. 3. In response to a user input to the “Done” button 420, a document generation component (such as the document generation component 115 described with reference to FIG. 1) generates a set of document previews for a set of documents corresponding to the data structure.

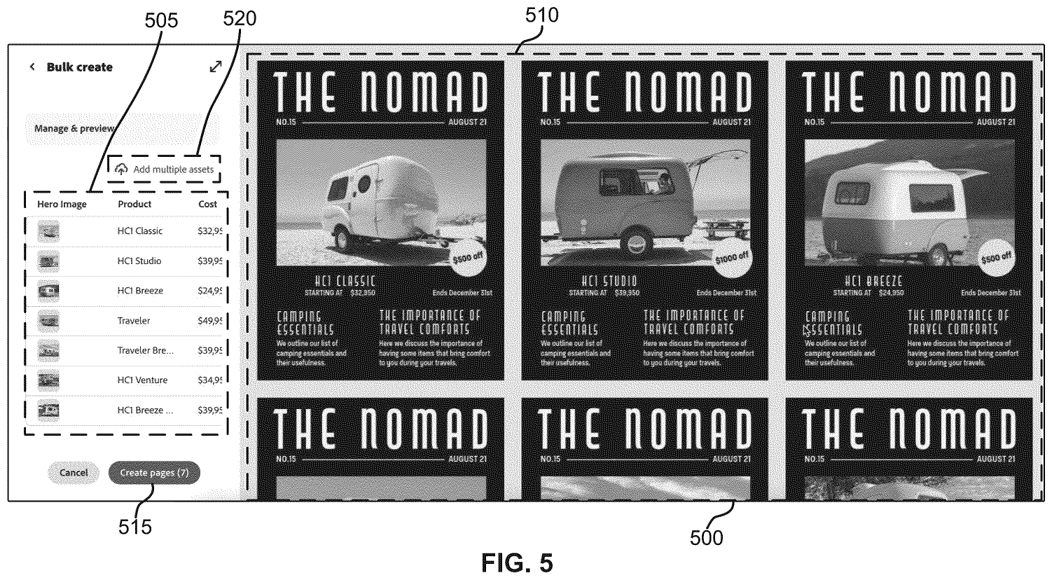

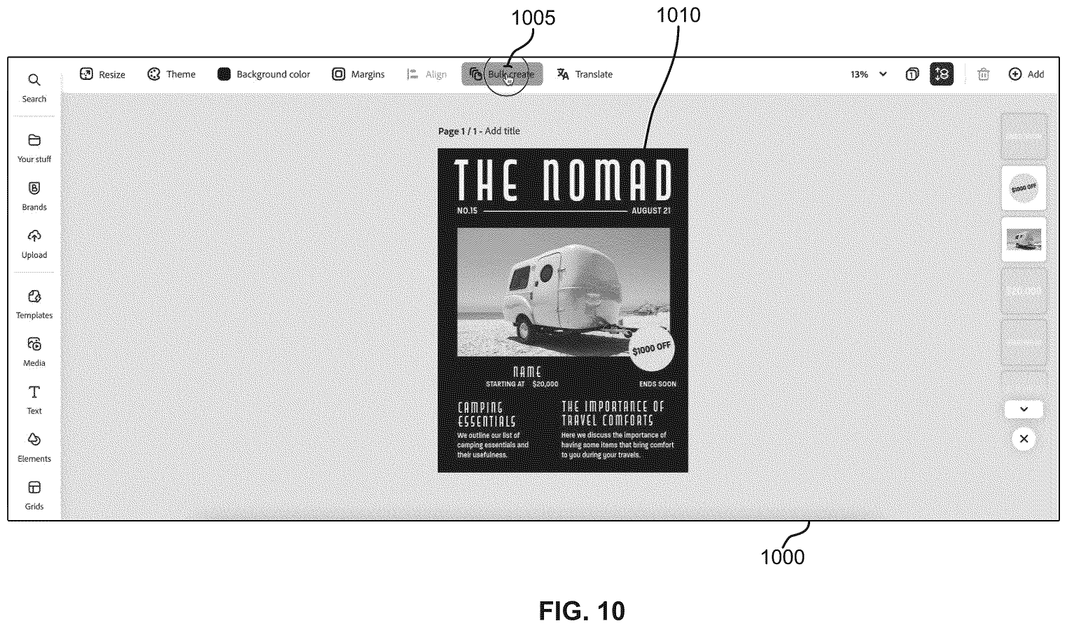

For example, in some embodiments, the document generation component generates the set of document previews by respectively populating fields of a document template (such as the document template 1010 described with reference to FIG. 10) with corresponding document attributes from corresponding elements of data structure 405, such that each document preview corresponds to one element of data structure 405. The set of document previews comprises visual (e.g., image) representations of a set of documents. User interface 400 may display the set of document previews as described with reference to FIG. 5.

User interface 400 is an example of, or includes aspects of, the corresponding element described with reference to FIGS. 1, 3, and 5-13. Data structure 405 is an example of, or includes aspects of, the corresponding element described with reference to FIGS. 3, 5, and 7-9. Element 410 is an example of, or includes aspects of, the corresponding element described with reference to FIG. 3.

FIG. 5 shows an example of a user interface 500 for displaying document previews according to aspects of the present disclosure. In one aspect, user interface 500 includes data structure 505, document previews 510, “Create pages” button 515, and “Add multiple assets” button 520.

Referring to FIG. 5, user interface 500 displays a data structure (e.g., data structure 505) adjacent to document previews (e.g., document previews 510) generated by linking media assets to documents via a user input to a data structure as described with reference to FIG. 3. Each document preview shown by user interface 500 comprises a visual representation of a document. Each document preview includes text elements corresponding to document attributes of an element of the data structure.

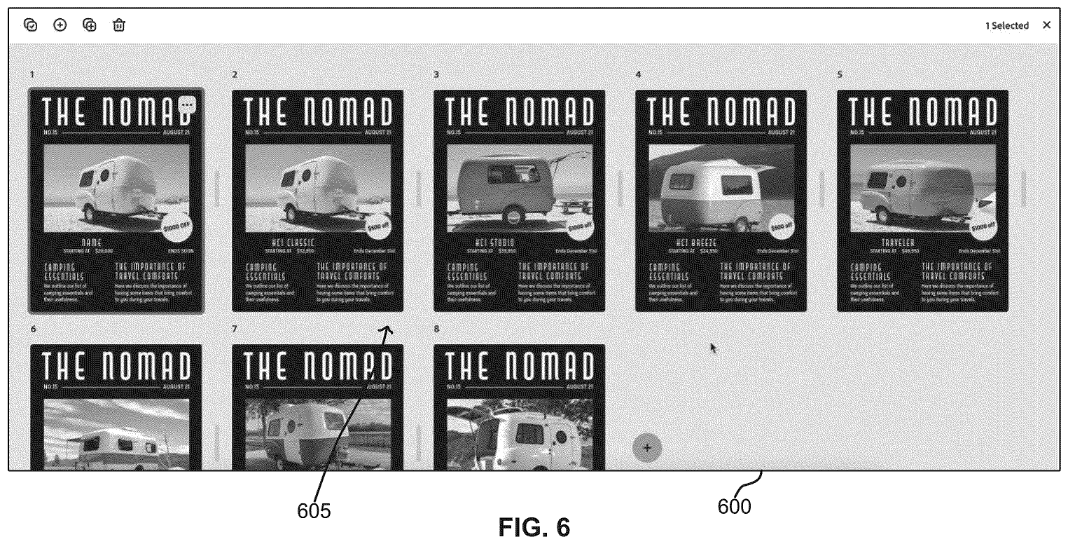

In response to an input to a “Create pages” button 515, a document generation component generates a set of documents corresponding to the set of document previews. For example, in some embodiments, the document generation component generates the set of documents by respectively populating fields of a document template (such as the document template 1010 described with reference to FIG. 10) with corresponding document attributes from corresponding elements of data structure 505, such that each document preview corresponds to one element of data structure 505. Representations of the set of documents are displayed as described with reference to FIG. 6. In response to an input to “Add multiple assets” button 520, a user interface 700 as described with reference to FIG. 7 is displayed.

User interface 500 is an example of, or includes aspects of, the corresponding element described with reference to FIGS. 1, 3, 4, and 6-13. Data structure 505 is an example of, or includes aspects of, the corresponding element described with reference to FIGS. 3, 4, and 7-9.

FIG. 6 shows an example of a user interface 600 for displaying representations of documents according to aspects of the present disclosure. In one aspect, user interface 600 includes document representations 605.

Referring to FIG. 6, user interface 600 displays representations of a set of documents (e.g., document representations 605) generated as described with reference to FIG. 5. Each of the documents comprises a media file including elements corresponding to document attributes of an element of a data structure. A user may obtain one or more of the documents (for example, via a downloading process) by providing a user input to a corresponding document representation.

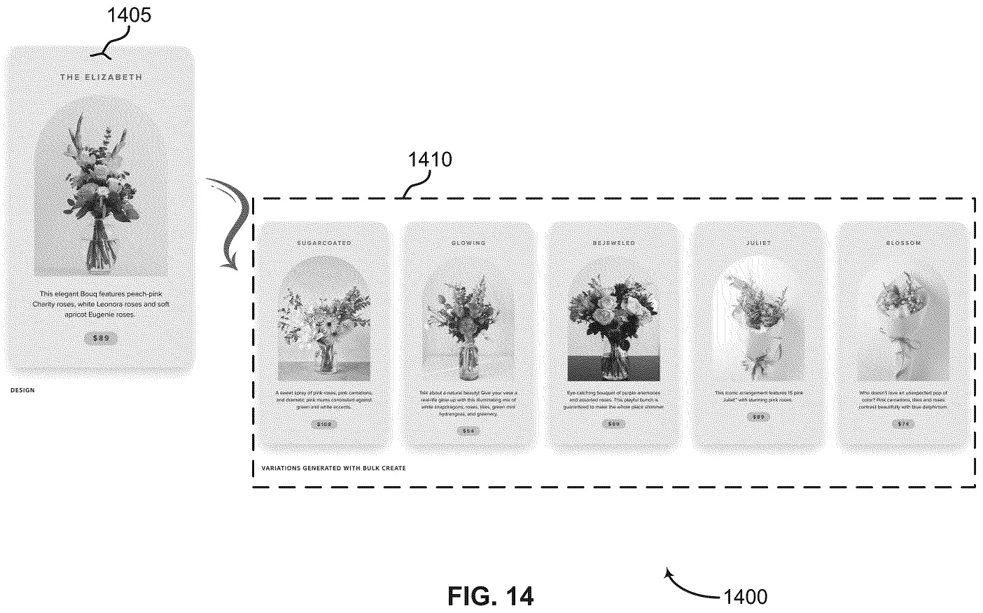

User interface 600 is an example of, or includes aspects of, the corresponding element described with reference to FIGS. 1, 3-5, and 7-13. Document representations 605 are an example of, or include aspects of, the corresponding elements described with reference to FIG. 14.

FIG. 7 shows an example of a user interface 700 for obtaining local media assets according to aspects of the present disclosure. In one aspect, user interface 700 includes data structure 705, “Assets” button 710, and media assets box 715.

Referring to FIG. 7, user interface 700 displays a data structure (e.g., data structure 705) adjacent to “Assets” button 710 and media assets box 715. A user may provide an input to media assets box 715 to provide media assets to user interface 700, where the media assets are stored locally on a user device that is displaying user interface 700. Example inputs include drag-and-drop inputs of the media assets to media assets box 715, or a selection of the media assets via a file browser.

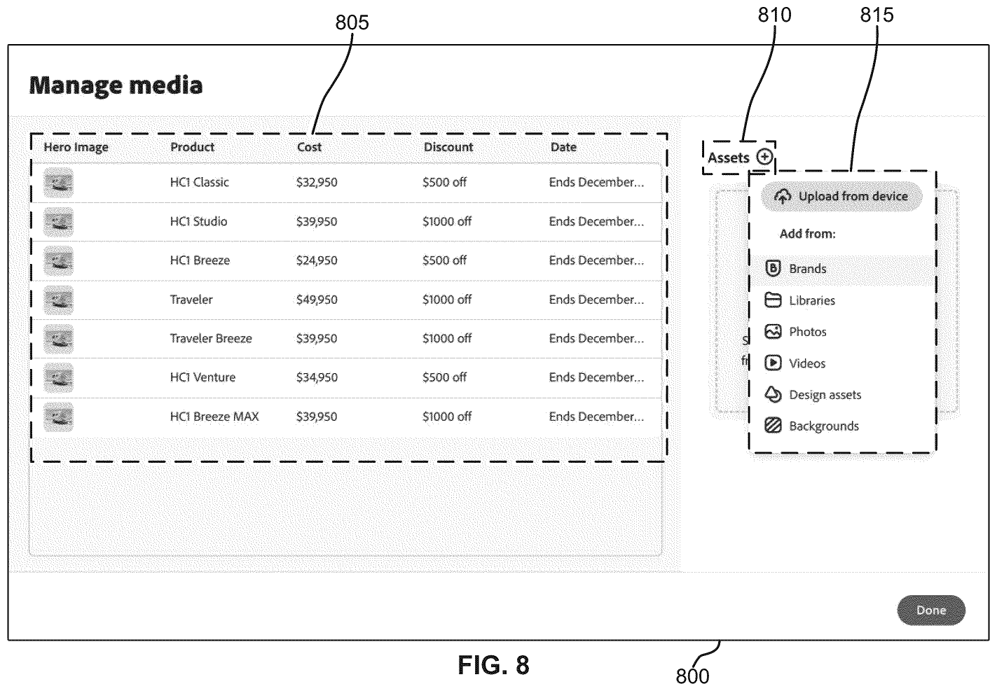

User interface 700 is an example of, or includes aspects of, the corresponding element described with reference to FIGS. 1, 3-6, and 8-13. Data structure 705 is an example of, or includes aspects of, the corresponding element described with reference to FIGS. 3-5, 8, and 9. “Assets” button 710 is an example of, or includes aspects of, the corresponding element described with reference to FIG. 8.

FIG. 8 shows an example of a user interface 800 for obtaining nonlocal media assets according to aspects of the present disclosure. In one aspect, user interface 800 includes data structure 805, “Assets” button 810, and media asset category list 815.

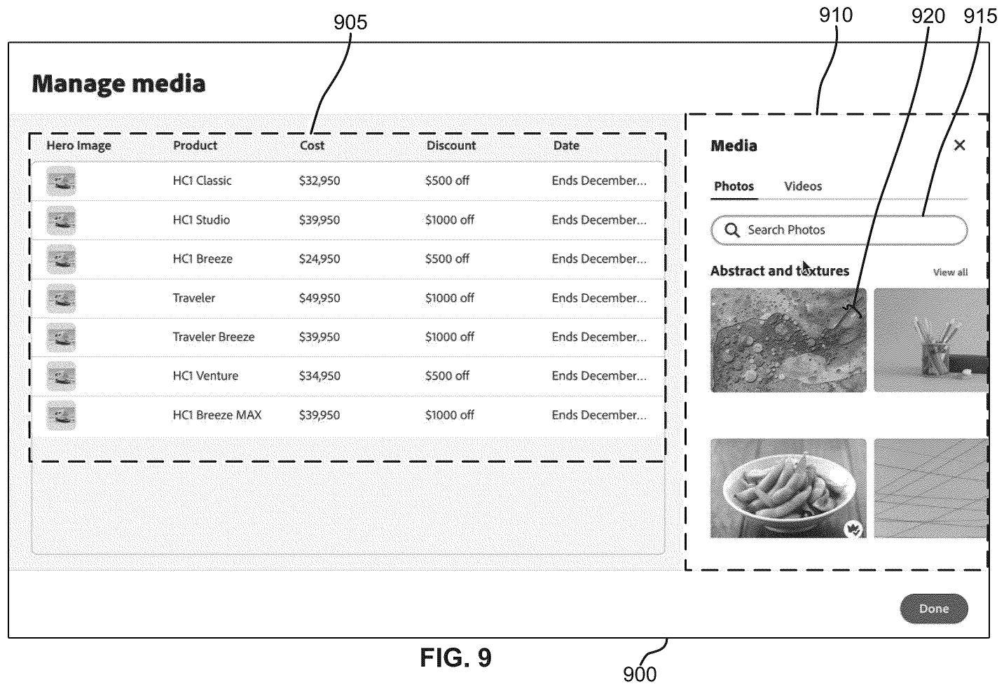

Referring to FIG. 8, user interface 800 displays a data structure (e.g., data structure 805) adjacent to “Assets” button 810. In response to an input to “Assets” button 810, user interface 800 displays media asset category list 815. Media asset category list 815 includes a list of categories of media assets that are stored externally to a user device, such as in a database, like the database 125 described with reference to FIG. 1. In the example of FIG. 8, media asset category list 815 includes categories “Brands”, “Libraries”, “Photos”, “Videos”, “Design assets”, and “Backgrounds”. A user may select one of the media asset categories to display media assets included in the media asset category, for example as described with reference to FIG. 9.

User interface 800 is an example of, or includes aspects of, the corresponding element described with reference to FIGS. 1, 3-7, and 9-13. Data structure 805 is an example of, or includes aspects of, the corresponding element described with reference to FIGS. 3-5, 7, and 9. “Assets” button 810 is an example of, or includes aspects of, the corresponding element described with reference to FIG. 7.

FIG. 9 shows an example of a user interface 900 for previewing nonlocal media assets according to aspects of the present disclosure. In one aspect, user interface 900 includes data structure 905, media asset preview pane 910, and media asset 920. In one aspect, media asset preview pane 910 includes search box 915.

Referring to FIG. 9, user interface 900 displays a data structure (e.g., data structure 905) adjacent to media asset preview pane 910 in response to a selection of a “Photos” media asset category as described with reference to FIG. 8. Media asset preview pane 910 includes one or more media assets (e.g., media asset 920) associated with the “Photos” media category and stored in a cloud storage location, such as the database 125 described with reference to FIG. 1. A user may drag the media asset onto an element of the data structure to link the media asset to a document corresponding to the row as described with reference to FIG. 3. A user may search for a media asset using the search box 915 of media asset preview pane 910.

User interface 900 is an example of, or includes aspects of, the corresponding element described with reference to FIGS. 1, 3-8, and 10-13. Data structure 905 is an example of, or includes aspects of, the corresponding element described with reference to FIGS. 3-5, 7, and 8.

FIG. 10 shows an example of a user interface 1000 for displaying a document template according to aspects of the present disclosure. The example shown includes user interface 1000 and document template 1010. In one aspect, user interface 1000 includes “Bulk create” button 1005.

Referring to FIG. 10, a user provides an input to “Bulk create” button 1005 of user interface 1000 to initiate a document generation process based on a document template (e.g., document template 1010) displayed by user interface 1000. In some embodiments, a document template is a representation of a document including user-selectable elements. In response to the input to “Bulk create” button 1005, user interface 1000 displays an element population pane as described with reference to FIG. 11.

User interface 1000 is an example of, or includes aspects of, the corresponding element described with reference to FIGS. 1, 3-9, and 11-13. Document template 1010 is an example of, or includes aspects of, the corresponding element described with reference to FIGS. 11-14.

FIG. 11 shows an example of a user interface 1100 for selecting a text element according to aspects of the present disclosure. The example shown includes user interface 1100 and document template 1120. In one aspect, user interface 1100 includes element population pane 1105. In one aspect, element population pane 1105 includes linked media asset button 1110 and “Connect Element” button 1115. In one aspect, document template 1120 includes media asset element 1125 and selected text element 1130.

Referring to FIG. 11, user interface 1100 displays element population pane 1105 adjacent to a document template (e.g., document template 1120). Element population pane 1105 shows linked media asset button 1110 indicating that a media asset element (e.g., media asset element 1125) is included in the document template, and that the media asset element may be populated with one or more media assets as described with reference to FIG. 3.

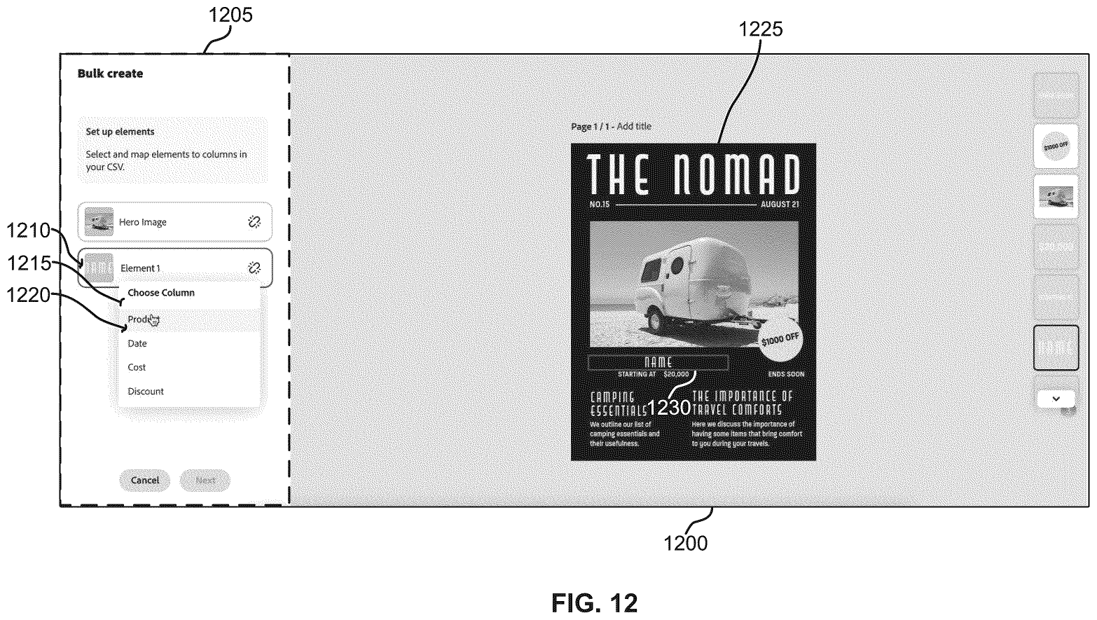

A user may provide a text file (e.g., a comma-separated values (CSV) file) to user interface 1100. The text file may include column headers corresponding to text element categories and values for the text element categories. In response to receiving the text file and a selection of an element of the document template (e.g., selected text element 1130), element population pane 1105 displays “Connect Element” button 1115. In response to an input to “Connect Element” button 1115, user interface 1100 displays a column selection menu as described with reference to FIG. 12.

User interface 1100 is an example of, or includes aspects of, the corresponding element described with reference to FIGS. 1, 3-10, 12, and 13. Element population pane 1105 is an example of, or includes aspects of, the corresponding element described with reference to FIGS. 12 and 13. Document template 1120 is an example of, or includes aspects of, the corresponding element described with reference to FIGS. 10, and 12-14. Selected text element 1130 is an example of, or includes aspects of, the corresponding element described with reference to FIGS. 12 and 13.

FIG. 12 shows an example of a user interface 1200 for connecting a text element to a document attribute category according to aspects of the present disclosure. The example shown includes user interface 1200 and document template 1225. In one aspect, user interface 1200 includes element population pane 1205. In one aspect, element population pane 1205 includes element selection button 1210. In one aspect, element selection button 1210 includes column selection menu 1215. In one aspect, column selection menu 1215 includes column header 1220. In one aspect, document template 1225 includes selected text element 1230.

Referring to FIG. 12, user interface 1200 displays element population pane 1205 adjacent to a document template (e.g., document template 1225). In response to a selection of an element of the document template and a “Connect Element” button as described with reference to FIG. 11, user interface 1200 displays element selection button 1210 and a column selection menu (e.g., column selection menu 1215). The column selection menu includes a list of values of column headers of a text file (e.g., a CSV file) provided by a user as described with reference to FIG. 11. A user may select a column header (e.g., column header 1220, “Product”) from the column selection menu to link a currently selected element of the document template (e.g., selected text element 1230) to values of a column of the text file corresponding to the selected column header. User interface 1200 may show an element population pane showing linked document template elements as described with reference to FIG. 13.

User interface 1200 is an example of, or includes aspects of, the corresponding element described with reference to FIGS. 1, 3-11, and 13. Element population pane 1205 is an example of, or includes aspects of, the corresponding element described with reference to FIGS. 11 and 13. Document template 1225 is an example of, or includes aspects of, the corresponding element described with reference to FIGS. 10, 11, 13, and 14. Selected text element 1230 is an example of, or includes aspects of, the corresponding element described with reference to FIGS. 11 and 13.

FIG. 13 shows an example of a user interface 1300 for displaying connected text elements according to aspects of the present disclosure. The example shown includes user interface 1300 and document template 1335. In one aspect, user interface 1300 includes element population pane 1305. In one aspect, element population pane 1305 includes first selected column header 1310, second selected column header 1315, third selected column header 1320, fourth selected column header 1325, and “Next” button 1330. In one aspect, document template 1335 includes selected text element 1340.

Referring to FIG. 13, user interface 1300 shows element population pane 1305 adjacent to a document template (e.g., document template 1335). User interface 1300 shows currently selected text element 1340 of document template 1335. Element population pane 1305 shows that values of a user-uploaded text file respectively corresponding to first selected column header 1310, second selected column header 1315, third selected column header 1320, and fourth selected column header 1325 have been linked to various elements of document template 1335 as described with reference to FIG. 12.

In response to receiving an input to “Next” button 1330, a document generation component generates a set of document previews by populating the document template with values from the text file. For example, the document generation component generates one document preview per row of the text file, where each generated document preview includes a value from the text file in a location and with a formatting corresponding to a linked document template element. In some embodiments, where a value from the text file would not fit within a box corresponding to a document template element, the document generation component reduces a font size of the value so that the value fits within the box.

User interface 1300 generates a data structure (such as the data structure 305 described with reference to FIG. 3), where column headers of the data structure correspond to column headers of the text file, and document attributes of the elements of the data structure correspond to row values from the text file. The document previews may be displayed as described with reference to FIG. 5. A user may add one or more media assets to the document previews as described with reference to FIGS. 3 and 7-9 by selecting an “Add multiple assets” button as described with reference to FIG. 5.

User interface 1300 is an example of, or includes aspects of, the corresponding element described with reference to FIG. 1, and 3-12. Element population pane 1305 is an example of, or includes aspects of, the corresponding element described with reference to FIGS. 11 and 12. Document template 1335 is an example of, or includes aspects of, the corresponding element described with reference to FIGS. 10-12, and 14. Selected text element 1340 is an example of, or includes aspects of, the corresponding element described with reference to FIGS. 11 and 12.

FIG. 14 shows an example 1400 of generated documents according to aspects of the present disclosure. The example shown includes document template 1405 and documents 1410.

Referring to FIG. 14, documents 1410 are examples of documents generated based on document template 1405 by populating text elements of document template 1405 with values from a text file as described with reference to FIGS. 10-13 and by populating a media asset element of document template 1405 with stored images as described with reference to FIGS. 3-9.

Document template 1405 is an example of, or includes aspects of, the corresponding element described with reference to FIGS. 10-13. Documents 1410 are an example of, or include aspects of, the corresponding elements described with reference to FIG. 6.

### Media Generation

FIG. 15 shows an example of a method 1500 for generating a set of documents including media assets according to aspects of the present disclosure. Referring to FIG. 15, a media generation system (such as the media generation system 100 described with reference to FIG. 1) generate a documents based on a user inputs that links an element of a data structure to a media asset, such as an images or a video. Because the data structure is displayed alongside the media asset, the linking user input is efficient and intuitive, and the media generation system therefore provides for an efficient generation of a document including a media asset. In some embodiments, the efficiency of the linking user input allows for an efficient bulk generation of a set of documents.

At operation 1505, the system displays a data structure and a set of media assets, where each element of the data structure includes a set of document attributes. In some cases, the operations of this step refer to, or may be performed by, a user interface as described with reference to FIGS. 1 and 3-13. In an example, the user interface displays the data structure and the set of media assets as described with reference to FIG. 3. In some embodiments, the data structure is displayed in a first window and the set of media assets are displayed in a second window adjacent to the first window. In some embodiments, a set of columns of the data structure correspond to categories of the set of document attributes.

At operation 1510, the system receives a user input linking a media asset of the set of media assets to a corresponding element of the data structure. In some cases, the operations of this step refer to, or may be performed by, a user interface as described with reference to FIGS. 1 and 3-13. In an example, the user interface receives the user input as described with reference to FIG. 3. In some embodiments, the user input comprises a drag-and-drop operation from the set of media assets to the data structure.

At operation 1515, the system generates a document based on the user input, where the document includes the media asset and set of document attributes from the corresponding element of the data structure. In some cases, the operations of this step refer to, or may be performed by, a document generation component as described with reference to FIG. 1. In an example, the document generation component generates the document as described with refence to FIGS. 5-6.

According to some aspects, the document generation component obtains a document template, where the document is generated based on the document template. In some embodiments, the set of document attributes correspond to fields of the document template. In some embodiments, the document generation component generates a preview corresponding to the document, where the preview includes the media asset and the set of document attributes from the corresponding element of the data structure. In some embodiments, the user interface displays the preview adjacent to the data structure.

According to some aspects, the document generation component receives at least one additional user input linking each of the remaining media assets of the set of media assets to an element of the data structure. In some embodiments, the document generation component generates a set of documents corresponding to each of the remaining media assets based on the at least one additional user input.

FIG. 16 shows an example of a method 1600 for generating a document including a text element according to aspects of the present disclosure. Referring to FIG. 16, a user may generate a document based on a user input that links a media asset to an element of a data structure and a document template including a template element that is populated with a document attribute from the data structure.

At operation 1605, the system obtains a document template including a template element having a style. In some cases, the operations of this step refer to, or may be performed by, a user interface as described with reference to FIGS. 1 and 3-13. In an example, a user uploads the document template, such as the document template 1010 described with reference to FIG. 10, to the user interface, or selects the document template from a set of document templates displayed by the user interface. The template element is a field of the document that may be populated with text. A style refers to one or more of a color, a font, a font size, spacing, and justification for text within the template element.

At operation 1610, the system displays a data structure and a set of media assets. In some cases, the operations of this step refer to, or may be performed by, a user interface as described with reference to FIGS. 1 and 3-13. In an example, the user interface displays the data structure and the set of media assets as described with reference to FIG. 3. In some embodiments, the data structure is displayed in a first window and the set of media assets are displayed in a second window adjacent to the first window. In some embodiments, a set of columns of the data structure correspond categories of content (e.g., categories document attributes), and each element of the data structure includes sets of content (e.g., sets of document attributes).

At operation 1615, the system receives a user input linking a media asset of the set of media assets to a corresponding element of the data structure. In some cases, the operations of this step refer to, or may be performed by, a user interface as described with reference to FIGS. 1 and 3-13. In an example, the user interface receives the user input as described with reference to FIG. 3. In some embodiments, the user input comprises a drag-and-drop operation from the set of media assets to the data structure.

In some embodiments, the document generation component links content to the data structure as described with reference to FIGS. 10-13, such that each element of the data structure corresponds to a set of document attributes. In some embodiments, the user interface obtains the content from a data source, and the document generation component maps the content to the data structure.

At operation 1620, the system generates a document based on the document template and the user input, where the document includes the media asset and content from the corresponding element of the data structure and having the style of the template element. In some cases, the operations of this step refer to, or may be performed by, a document generation component as described with reference to FIG. 1. In an example, the document generation component generates the document as described with refence to FIGS. 5-6. According to some aspects, the document generation component populates a media asset element of the document template with the linked media asset and populates the template element with corresponding content (e.g., text) from the element of the data structure. The document generation component may resize the content based on a boundary of the template element.

In some embodiments, the set of document attributes correspond to fields of the document template. In some embodiments, the document generation component generates a preview corresponding to the document, where the preview includes the media asset and the set of document attributes from the corresponding element of the data structure. In some embodiments, the user interface displays the preview adjacent to the data structure.

According to some aspects, the document generation component receives at least one additional user input linking each of the remaining media assets of the set of media assets to an element of the data structure. In some embodiments, the document generation component generates a set of documents corresponding to each of the remaining media assets based on the at least one additional user input.

Accordingly, a method for media generation is described. One or more aspects of the method include displaying a data structure and a plurality of media assets, wherein each element of the data structure includes a plurality of document attributes; receiving a user input linking a media asset of the plurality of media assets to a corresponding element of the data structure; and generating a document based on the user input, wherein the document includes the media asset and plurality of document attributes from the corresponding element of the data structure.

Some examples of the method further include receiving at least one additional user input linking each of the remaining media assets of the plurality of media assets to an element of the data structure. Some examples further include generating a plurality of documents corresponding to each of the remaining media assets based on the at least one additional user input.

In some aspects, the data structure is displayed in a first window and the plurality of media assets are displayed in a second window adjacent to the first window. In some aspects, the user input comprises a drag-and-drop operation from the plurality of media assets to the data structure.

Some examples of the method further include obtaining a document template, wherein the document is generated based on the document template. In some aspects, the plurality of document attributes correspond to fields of the document template. In some aspects, a plurality of columns of the data structure correspond to the plurality of document attributes.

Some examples of the method further include generating a preview corresponding to the document, wherein the preview includes the media asset and the plurality of document attributes from the corresponding element of the data structure. Some examples of the method further include displaying the preview adjacent to the data structure.

A method for media generation is described. One or more aspects of the method include obtaining a document template comprising a template element having a style; displaying a data structure and a plurality of media assets; receiving a user input linking a media asset of the plurality of media assets to a corresponding element of the data structure; and generating a document based on the document template and the user input, wherein the document includes the media asset and content from the corresponding element of the data structure and having the style of the template element. In some aspects, the style comprises one or more of a font, a font size, and spacing.

Some examples of the method further include receiving at least one additional user input linking each of the remaining media assets of the plurality of media assets to an element of the data structure. Some examples further include generating a plurality of documents corresponding to each of the remaining media assets based on the at least one additional user input. In some aspects, the data structure is displayed in a first window and the plurality of media assets are displayed in a second window adjacent to the first window. In some aspects, the user input comprises a drag-and-drop operation from the plurality of media assets to the data structure.

Some examples of the method further include obtaining the content from a data source. Some examples further include mapping the content to the data structure. Some examples of the method further include resizing the content based on a boundary of the template element.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

### Media Generation Apparatus

FIG. 17 shows an example of a computing device 1700 according to aspects of the present disclosure. Computing device 1700 is an example of, or includes aspects of, the media generation apparatus described with reference to FIGS. 1 and 18. In one aspect, computing device 1700 includes processor(s) 1705, memory subsystem 1710, communication interface 1715, I/O interface 1720, user interface component(s) 1725, and channel 1730. In some embodiments, computing device 1700 includes one or more processors 1705 that can execute instructions stored in memory subsystem 1710.

According to some aspects, computing device 1700 includes one or more processors 1705. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1715 operates at a boundary between communicating entities (such as computing device 1700, one or more user devices, a cloud, and one or more databases) and channel 1730 and can record and process communications. In some cases, communication interface 1715 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1720 is controlled by an I/O controller to manage input and output signals for computing device 1700. In some cases, I/O interface 1720 manages peripherals not integrated into computing device 1700. In some cases, I/O interface 1720 represents a physical connection or port to an external peripheral. In some cases, the I/O controller uses an operating system such as iOS®, ANDROID®, MS-DOS®, MS-WINDOWS®, O S/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1720 or via hardware components controlled by the I/O controller.

According to some aspects, user interface component(s) 1725 enable a user to interact with computing device 1700. In some cases, user interface component(s) 1725 include an audio device, such as an external speaker system, an external display device such as a display screen, an input device (e.g., a remote-control device interfaced with a user interface directly or through the I/O controller), or a combination thereof. In some cases, user interface component(s) 1725 include a GUI.

FIG. 18 shows an example of a media generation apparatus 1800 according to aspects of the present disclosure. Media generation apparatus 1800 is an example of, or includes aspects of, the corresponding element described with reference to FIGS. 1 and 17. In some embodiments, media generation apparatus 1800 includes processor unit 1805, memory unit 1810, and I/O module 1815.

Processor unit 1805 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1805 is configured to operate a memory array using a memory controller. In other cases, a memory controller is integrated into processor unit 1805. In some cases, processor unit 1805 is configured to execute computer-readable instructions stored in memory unit 1810 to perform various functions. In some aspects, processor unit 1805 includes special purpose components for modem processing, baseband processing, digital signal processing, or transmission processing. According to some aspects, processor unit 1805 comprises one or more processors 1705 described with reference to FIG. 17.

Memory unit 1810 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1805 to perform various functions described herein.

In some cases, memory unit 1810 includes a basic input/output system (BIOS) that controls basic hardware or software operations, such as an interaction with peripheral components or devices. In some cases, memory unit 1810 includes a memory controller that operates memory cells of memory unit 1810. For example, the memory controller may include a row decoder, column decoder, or both. In some cases, memory cells within memory unit 1810 store information in the form of a logical state. According to some aspects, memory unit 1810 is an example of the memory subsystem 1710 described with reference to FIG. 17.

According to some aspects, media generation apparatus 1800 uses one or more processors of processor unit 1805 to execute instructions stored in memory unit 1810 to perform functions described herein. For example, the media generation apparatus 1800 may perform operations comprising displaying a data structure and a plurality of media assets, wherein each element of the data structure includes a plurality of document attributes; receiving a user input linking a media asset of the plurality of media assets to a corresponding element of the data structure; and generating a document based on the user input, wherein the document includes the media asset and plurality of document attributes from the corresponding element of the data structure.

I/O module 1815 receives inputs from and transmits outputs of media processing apparatus 1800 to other devices or users. According to some aspects, I/O module 1815 is an example of the I/O interface 1720 described with reference to FIG. 17.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application-specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for media generation, comprising:
displaying a data structure and a plurality of media assets, wherein an element of the data structure includes a plurality of document attributes;
receiving a user input linking a media asset of the plurality of media assets to the element of the data structure; and
generating a document based on the user input, wherein the document includes the media asset and plurality of document attributes from the corresponding element of the data structure.

2. The method of claim 1, further comprising:
receiving at least one additional user input linking each of a plurality of remaining media assets of the plurality of media assets to an additional element of the data structure; and
generating a plurality of documents corresponding to each of the remaining media assets based on the at least one additional user input.

3. The method of claim 1, wherein:
the data structure is displayed in a first window and the plurality of media assets are displayed in a second window adjacent to the first window.

4. The method of claim 1, wherein:
the user input comprises a drag-and-drop operation from the plurality of media assets to the data structure.

5. The method of claim 1, further comprising:
obtaining a document template, wherein the document is generated based on the document template.

6. The method of claim 5, wherein:
the plurality of attributes correspond to fields of the document template.

7. The method of claim 1, wherein:
a plurality of columns of the data structure correspond to the plurality of document attributes.

8. The method of claim 1, further comprising:
generating a preview corresponding to the document, wherein the preview includes the media asset and the plurality of document attributes from the corresponding element of the data structure.

9. The method of claim 8, further comprising:
displaying the preview adjacent to the data structure.

10. A non-transitory computer readable medium storing code for media generation, the code comprising instructions that, when executed by at least one processor, cause the at least one processor to perform operations comprising:
obtaining a document template comprising a template element having a style;
displaying a data structure and a plurality of media assets;
receiving a user input linking a media asset of the plurality of media assets to a corresponding element of the data structure; and
generating a document based on the document template and the user input, wherein the document includes the media asset and content from the corresponding element of the data structure and having the style of the template element.

11. The non-transitory computer readable medium of claim 10, wherein:
the style comprises one or more of a font, a font size, and spacing.

12. The non-transitory computer readable medium of claim 10, the code further comprising instructions that, when executed by the at least one processor, cause the at least one processor to perform operations comprising:
receiving at least one additional user input linking each of the remaining media assets of the plurality of media assets to an element of the data structure; and
generating a plurality of documents corresponding to each of the remaining media assets based on the at least one additional user input.

13. The non-transitory computer readable medium of claim 10, wherein:
the data structure is displayed in a first window and the plurality of media assets are displayed in a second window adjacent to the first window.

14. The non-transitory computer readable medium of claim 10, wherein:
the user input comprises a drag-and-drop operation from the plurality of media assets to the data structure.

15. The non-transitory computer readable medium of claim 10, the code further comprising instructions that, when executed by the at least one processor, cause the at least one processor to perform operations comprising:
obtaining the content from a data source; and
mapping the content to the data structure.

16. The non-transitory computer readable medium of claim 10, the code further comprising instructions that, when executed by the at least one processor, cause the at least one processor to perform operations comprising:
resizing the content based on a boundary of the template element.

17. A system comprising:
a memory component; and
a processing device coupled to the memory component, the processing device configured to perform operations comprising:
displaying a data structure and a plurality of media assets, wherein each element of the data structure includes a plurality of document attributes;
receiving a user input linking a media asset of the plurality of media assets to a corresponding element of the data structure; and
generating a document based on the user input, wherein the document includes the media asset and plurality of document attributes from the corresponding element of the data structure.

18. The system of claim 17, the processing device being further configured to perform operations comprising:
receiving at least one additional user input linking each of the remaining media assets of the plurality of media assets to an element of the data structure; and
generating a plurality of documents corresponding to each of the remaining media assets based on the at least one additional user input.

19. The system of claim 17, wherein:
the data structure is displayed in a first window and the plurality of media assets are displayed in a second window adjacent to the first window.

20. The system of claim 17, wherein:
the user input comprises a drag-and-drop operation from the plurality of media assets to the data structure.
